(19) United States
(12) Patent Application Publication
(10) Pub. No.: US 2014/0365341 A1
(43) Pub. Date: Dec. 11, 2014

(54) STORE OF THE FUTURE

(71) Applicants: Matthew Bret MacLaurin, Santa Cruz, CA (US); David Geisinger, Plymouth, MA (US); Hsin-Yi Chien, San Jose, CA (US); Flynn Joffray, Santa Cruz, CA (US); James Ross Skorupski, San Jose, CA (US); Healey Cypher, San Francisco, CA (US)

(72) Inventors: Matthew Bret MacLaurin, Santa Cruz, CA (US); David Geisinger, Plymouth, MA (US); Hsin-Yi Chien, San Jose, CA (US); Flynn Joffray, Santa Cruz, CA (US); James Ross Skorupski, San Jose, CA (US); Healey Cypher, San Francisco, CA (US)

(73) Assignee: EBAY INC., SAN JOSE, CA (US)

(21) Appl. No.: 14/109,737

(22) Filed: Dec. 17, 2013

Related U.S. Application Data
(60) Provisional application No. 61/831,607, filed on Jun. 5, 2013.

(51) Int. Cl. G06Q 30/06; G06Q 20/32

(52) U.S. Cl. CPC G06Q 30/0635; G06Q 20/322
USPC 705/26.81

(57) ABSTRACT

Techniques for facilitating commerce and retail transactions are described. According to various embodiments, a user selection of a product item offered for sale by a retail store is received, via a shoppable window user interface associated with the retail store. Thereafter, a user request to perform a checkout process for purchase of the product item is received, via the shoppable window user interface. The checkout process for the purchase of the product item is then performed, via a user interface displayed on a smartphone associated with the user.

### CROSS-REFERENCE TO RELATED APPLICATIONS

This application claims the priority benefit of U.S. Provisional Application No. 61/831,607, filed Jun. 5, 2013, which is incorporated herein by reference.

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software and data as described below and in the drawings that form a part of this document: Copyright eBay, Inc. 2013, All Rights Reserved.

### TECHNICAL FIELD

The present application relates generally to data processing systems and, in one specific example, to techniques for facilitating commerce and retail transactions.

### BACKGROUND

Traditional retail stores typically include large amounts of space for stocking various inventory and items for sale. Generally, a customer will enter the store, browse through a possibly voluminous amount items available for sale, select one of the items that they are interested in, try that item on in a fitting room (e.g., in the case of clothing), and then proceed to a checkout aisle in order to pay for the item.

### BRIEF DESCRIPTION OF THE DRAWINGS

Some embodiments are illustrated by way of example and not limitation in the figures of the accompanying drawings in which:

FIG. 1 is a network diagram depicting a client-server system, within which one example embodiment may be deployed;

FIG. 2 is a block diagram of an example system, according to various embodiments;

FIG. 3 is a flowchart illustrating an example method, according to various embodiments;

FIG. 4 is a flowchart illustrating an example method, according to various embodiments;

FIG. 5 illustrates an exemplary portion of a shoppable window user interface displayed on a shoppable window or a kiosk, according to various embodiments;

FIG. 6 illustrates an exemplary portion of a shoppable window user interface displayed on a shoppable window or a kiosk, according to various embodiments;

FIG. 7 illustrates an exemplary portion of a shoppable window user interface displayed on a shoppable window or a kiosk, according to various embodiments;

FIG. 8 illustrates an exemplary portion of a shoppable window user interface displayed on a shoppable window or a kiosk, according to various embodiments;

FIG. 9 illustrates exemplary portions of various user interfaces for completing a checkout operation that may be displayed on a mobile device, according to various embodiments;

FIG. 10 is a flowchart illustrating an example method, according to various embodiments;

FIG. 11 is a flowchart illustrating an example method, according to various embodiments;

FIG. 12 is a flowchart illustrating an example method, according to various embodiments;

FIG. 13 is a flowchart illustrating an example method, according to various embodiments;

FIG. 14 is a flowchart illustrating an example method, according to various embodiments;

FIG. 15 is a flowchart illustrating an example method, according to various embodiments;

FIG. 16 is a flowchart illustrating an example method, according to various embodiments;

FIG. 17 illustrates an exemplary portion of a map that may be displayed on a mobile device, according to various embodiments;

FIG. 18 is a flowchart illustrating an example method, according to various embodiments;

FIG. 19 illustrates an exemplary mobile device, according to various embodiments; and

FIG. 20 is a diagrammatic representation of a machine in the example form of a computer system within which a set of instructions, for causing the machine to perform any one or more of the methodologies discussed herein, may be executed.

### DETAILED DESCRIPTION

Example methods and systems for facilitating commerce and retail transactions are described. In the following description, for purposes of explanation, numerous specific details are set forth in order to provide a thorough understanding of example embodiments. It will be evident, however, to one skilled in the art that the present invention may be practiced without these specific details.

According to various exemplary embodiments, interactive display screen surfaces (e.g., touchscreens) may be incorporated in various positions and locations within and around retail stores, in order to enhance shopping experiences for consumers. For example, display surfaces (e.g., touchscreens) may be provided on interior walls of a retail store, on the ceiling of a retail store, on the floor of a retail store, in fitting rooms of a retail store, on exterior walls or storefronts of a retail store, and so on. In some embodiments, the aforementioned display surfaces displayed on exterior walls and storefronts may be referred to as shoppable windows, shoppable storefronts, digital walls, magic mirrors, and kiosks throughout. Hence, in some embodiments, the terms shoppable window and kiosk may be utilized interchangeably. Display surfaces such as the aforementioned shoppable windows may even be provided on walls or storefronts remote from active retail stores, such as unused storefronts of abandoned stores. The shoppable windows may be projected on to or displayed on exterior surfaces using any techniques or methods understood by those skilled in the art. In some embodiments, the shoppable windows may correspond to touchscreens that display various types of content. Since shoppable windows may be displayed on exterior walls or storefronts of a retail store 24 hours a day, users may shop from a store (via kiosk or shoppable windows) at any time.

Thus, according to various exemplary embodiments, a seamless multiscreen, multi-device, in-store (or out-of-store) commerce experience may be provided. For example, as described above, multiple display surfaces may be provided throughout a store, retail establishment, business, or other location, as well as on the user's smartphone. Each of these multiple surfaces may be interactive (e.g., touchscreens), and each surface may be interconnected in conjunction with the user's smartphone to provide an integrated interactive shopping experience to a user. In other words, the entire store and the user's smartphone may be viewed as a single interaction surface with different windows, where a single session continues as a user moves from screen to screen.

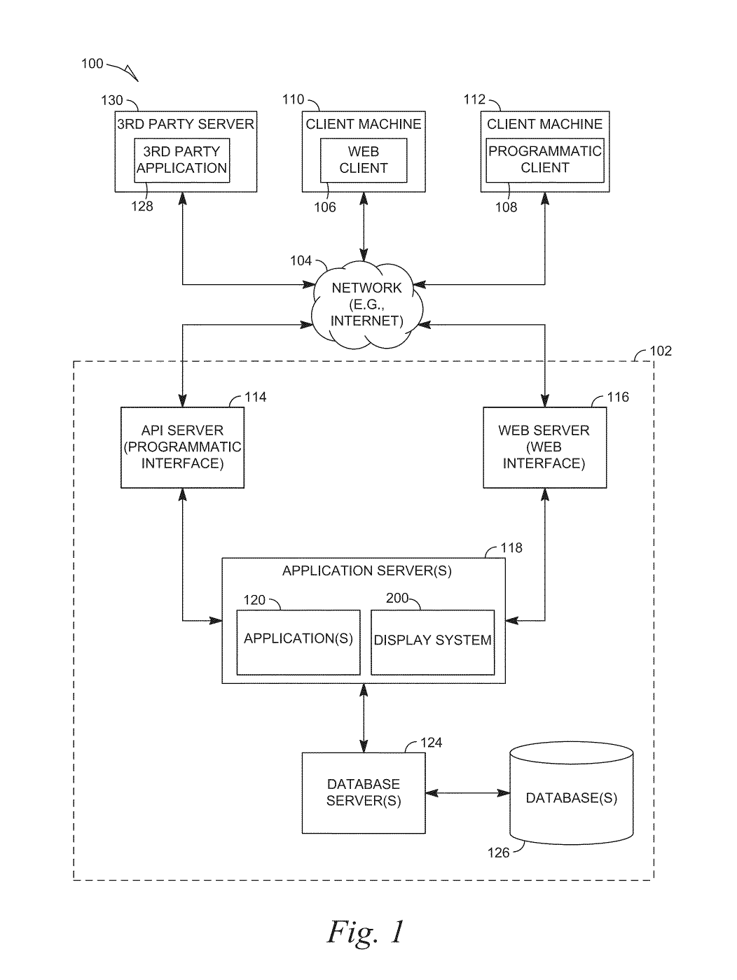

FIG. 1 is a network diagram depicting a client-server system 100, within which one example embodiment may be deployed. A networked system 102 provides server-side functionality via a network 104 (e.g., the Internet or Wide Area Network (WAN)) to one or more clients. FIG. 1 illustrates, for example, a web client 106 (e.g., a browser), and a programmatic client 108 executing on respective client machines 110 and 112.

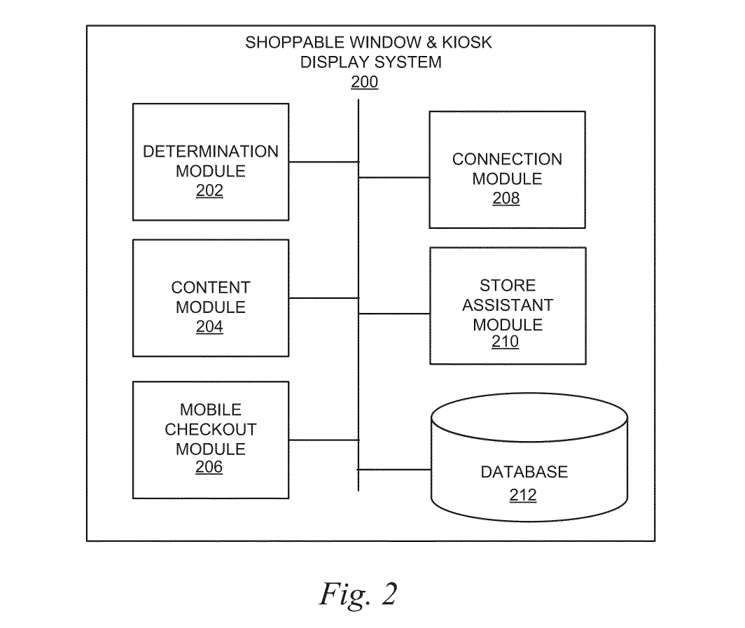

An Application Program Interface (API) server 114 and a web server 116 are coupled to, and provide programmatic and web interfaces respectively to, one or more application servers 118. The application servers 118 host one or more applications 120. The application servers 118 are, in turn, shown to be coupled to one or more databases servers 124 that facilitate access to one or more databases 126. According to various exemplary embodiments, the applications 120 may be implemented on or executed by one or more of the modules of the shoppable window commerce system 200 illustrated in FIG. 2. While the applications 120 are shown in FIG. 1 to form part of the networked system 102, it will be appreciated that, in alternative embodiments, the applications 120 may form part of a service that is separate and distinct from the networked system 102. With some embodiments, the application servers 118 hosts a display system 200 (which may also be referred to herein as an interactive commerce display system 200, a shoppable window display system 200, or a kiosk display system 200). The interactive commerce display system 200 is described in more detail below in conjunction with FIG. 2.

Further, while the system 100 shown in FIG. 1 employs a client-server architecture, the present invention is of course not limited to such an architecture, and could equally well find application in a distributed, or peer-to-peer, architecture system, for example. The various applications 120 could also be implemented as standalone software programs, which do not necessarily have networking capabilities.

The web client 106 accesses the various applications 120 via the web interface supported by the web server 116. Similarly, the programmatic client 108 accesses the various services and functions provided by the applications 120 via the programmatic interface provided by the API server 114.

FIG. 1 also illustrates a third party application 128, executing on a third party server machine 130, as having programmatic access to the networked system 102 via the programmatic interface provided by the API server 114. For example, the third party application 128 may, utilizing information retrieved from the networked system 102, support one or more features or functions on a website hosted by the third party. The third party website may, for example, provide one or more functions that are supported by the relevant applications of the networked system 102.

Turning now to FIG. 2, a display system 200 includes a determination module 202, a content module 204, a mobile checkout module 206, a connection module 208, a store assistant module 210, and a database 212. The modules of the display system 200 may be implemented on or executed by a single device such as an interactive commerce display device, or on separate devices interconnected via a network. The aforementioned interactive commerce display device may be, for example, one of the client machines (e.g. 110, 112) or application server(s) 118 illustrated in FIG. 1. As described in more detail below, the interactive commerce display system 200 may be associated with or included in a kiosk terminal, shoppable window, or similar display device. The operation of each of the aforementioned modules of the display system 200 will now be described in greater detail below in conjunction with the various figures.

According to various exemplary embodiments, the kiosk display system 200 may be associated with a kiosk located in a retail store, and may be configured to detect a number of “impressions” or “views” of the kiosk by people who are in close proximity to the kiosk or are visiting the retail store (e.g., shoppers, consumers, customers, etc.). For example, the number of impressions may represent a number of people considered to have viewed content displayed on a display screen of the kiosk.

In some embodiments, the kiosk display system 200 may determine a number of impressions by detecting the number of users that enter a predetermined zone around the kiosk, such as by detecting users that are located within a predetermined distance of the kiosk. Different predetermined distances may be established for different directions with respect to the front of the kiosk (e.g., a greater distance with respect to the front of the kiosk, a smaller distance with respect to the side of the kiosk, etc.). The kiosk may include a camera or other sensor (e.g., audio sensor, light sensor, infrared sensor, motion detection sensor, depth sensor, field sensor etc.) that detects when a user is located near the kiosk.

In some embodiments, the amount of time that the user spends in the aforementioned zone may be taken into account when recording impressions. For example, in some embodiments, the kiosk display system 200 may record an impression each time the user enters the aforementioned zone for any period of time. This may enable the kiosk display system 200 to count the number of people that walk past the kiosk as impressions. In other embodiments, the kiosk display system 200 will record an impression each time the user enters and remains within the zone for a predetermined time period (e.g., 5 seconds, 30 seconds, 1 min., etc.). This may enable the kiosk display system 200 to count the number of people that linger near the kiosk as impressions. In some embodiments, the kiosk display system 200 may take into account movement of users (e.g. by tracking speed or acceleration of users), in order for the kiosk display system 200 to differentiate between people that walk past the kiosk and people that stop and linger near the kiosk, for the purposes of recording impressions.

In some embodiments, the kiosk display system 200 may be able to detect when a user approaches the kiosk or faces the kiosk at a particular angle, orientation, or direction, for the purposes of recording impressions. For example, the kiosk may include a camera configured to detect facial features and body features of users near the kiosk. If the camera is able to detect all or most of the facial features of the user (e.g., from both sides of the face of the user), this may indicate that the user is facing the display screen of the kiosk, as opposed to if the camera can only detect the right side of the face of the user, for example. As another example, if the camera is able to detect both shoulders of the user, this may indicate that the user has “squared up” near the kiosk and that the user is facing the kiosk head-on, which may be recorded as an impression. The kiosk display system 200 may store impression information describing the number of impressions or an impression count (e.g., over various time periods such as one day, one week, one month, etc.) in a database (e.g., the database 212 illustrated in FIG. 2). Thus, according to various exemplary embodiments, kiosk intelligence may be utilized to determine a number of people walking by the kiosk, which ones square up to the kiosk, and so on.

According to various exemplary embodiments, an emotion library may be utilized to determine reaction to kiosk content. For example, in some embodiments, the kiosk display system 200 may detect and analyze facial features of the user in order to record impressions. The kiosk display system 200 may access an “emotion library” (e.g., stored in the database 212 illustrated in FIG. 2) describing various sample facial features and associated sample emotions. Accordingly, when a camera of the kiosk detects facial features of a given user, the kiosk display system 200 may compare these features to the sample facial features in the “emotion library”. If the kiosk display system 200 detects that a given user has facial features (e.g., smiling, grinning, laughing, etc.) corresponding to positive emotions (e.g., excitement, engagement, interest, etc.), then the kiosk display system 200 may record this as an impression or a positive impression. On the other hand, if the kiosk display system 200 detects that a given user has facial features (e.g., frown, closed eyes, etc.) corresponding to negative emotions (e.g., anger, disinterest, etc.), then the kiosk display system 200 may either prevent this from being recorded as an impression, or may record this as a different type of impression, such as a negative impression. Thus, the kiosk display system 200 may generate and maintain impression information describing a number of different types of impressions (such as positive impressions, negative impressions, etc.) in a database (e.g., the database 212).

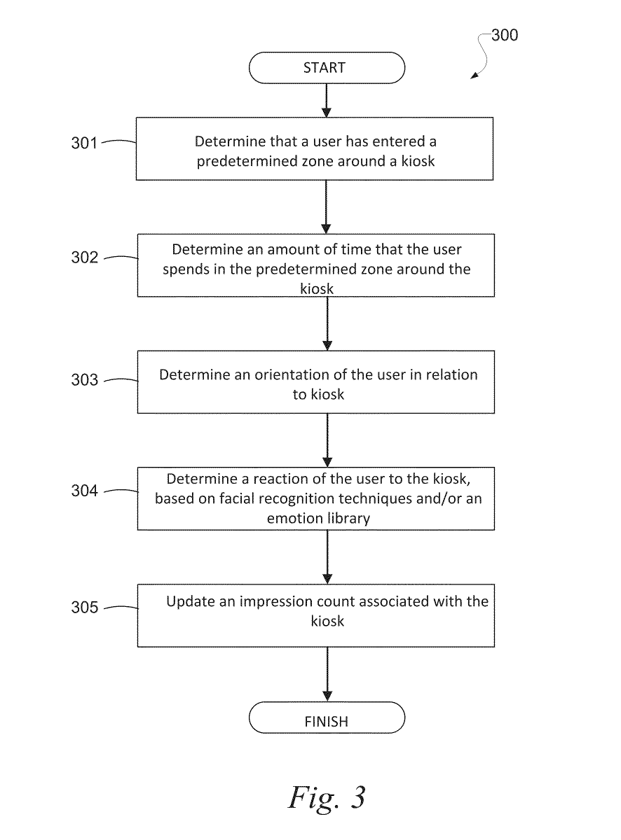

FIG. 3 is a flowchart illustrating an example method 300, consistent with various embodiments described above. The method 300 may be performed at least in part by, for example, the kiosk display system 200 illustrated in FIG. 2 (or an apparatus having similar modules, such as client machines 110 and 112 or application server 118 illustrated in FIG. 1). In operation 301, the determination module 202 determines that a user has entered a predetermined zone around a kiosk. In operation 302, the determination module 202 determines an amount of time that the user has spent in the predetermined zone around the kiosk. For example, the determination module 202 may check whether the user has spent at least a predetermined amount of time within the predetermined zone around the kiosk. In operation 303, the determination module 202 determines an orientation of the user in relation to kiosk. For example, the determination module 202 may confirm that the user is facing the kiosk, rather than facing away from the kiosk. In operation 304, the determination module 202 determines a reaction of the user to the kiosk, based on facial recognition techniques and/or an emotion library. For example, the determination module 202 may determine that the user is having a positive reaction (or is not having a negative reaction) to the content displayed on the kiosk. In operation 305, the determination module 202 updates an impression count associated with the kiosk, based on at least one of the determinations 301-304 in the method 300. Various operations in the method 300 may be omitted or rearranged, as necessary.

According to various exemplary embodiments, the kiosk may include a height-based display. For example, the kiosk may include a camera or other sensor (e.g., audio sensor, light sensor, infrared sensor, motion detection sensor, etc.) that detects when a user is located near the kiosk and the height of the user. In some embodiments, when a kiosk display system 200 detects that a user of a given height is currently viewing the kiosk, the kiosk display system 200 may adjust the content being displayed so that it is re-centered on a different portion of the display screen of the kiosk. For example, if the kiosk display system 200 detects that a tall user is currently viewing the kiosk, the kiosk display system 200 may re-center the content so that it is displayed higher in the display screen of the kiosk. On the other hand, if the kiosk display system 200 detects that a short user is currently viewing the kiosk, the kiosk display system 200 may re-center the content so that it is displayed lower in the display screen of the kiosk.

In some embodiments, the kiosk display system 200 may infer the age of the user, based on the height of the user. For example, if the kiosk display system 200 detects that a tall user is currently viewing the kiosk, the kiosk display system 200 may infer that the user is an adult, and the kiosk display system 200 may adjust the content being displayed accordingly. On the other hand, if the kiosk display system 200 detects that a short user is currently viewing the kiosk, the kiosk display system 200 may infer that the user is a teenager, young adult, or child (depending on the height of the user), and the kiosk display system 200 may adjust content being displayed accordingly (e.g., by displaying games, stories, children's books, toys, etc.).

According to various exemplary embodiments, a kiosk display system 200 is configured to simultaneously display different types of content directed at different target audiences in different portions of a display screen of the kiosk. For example, the kiosk display system 200 may display height-specific content for users having different heights, by splitting the display screen of the kiosk into two areas, including an upper/higher area for taller users and a lower area for shorter users. In some embodiments, the upper area may include content catered to adults, whereas the lower area may include content catered to young adults or children. In some embodiments, if the kiosk display system 200 detects that an adult and a child are currently using the kiosk (e.g., by detecting both a tall user and a short user standing in front of the kiosk, using various techniques described above), then the kiosk display system 200 may begin simultaneously displaying adult content in the upper area and child content in the lower area, as described above. In some embodiments, the kiosk display system 200 may allow interaction between content in the lower area and the upper area of the display screen. For example, if the lower area is catered to child content such as games, then the lower area may display a ball, and if the child user touches the ball and flicks it upward, the ball may appear to move upward into the upper content area that displays content for adults. The adults can then select the ball and flick it back down to the child area. Similarly, children can select other items, such as product items (e.g., toys or games) for sale, and flick them up to the upper areas of the display screen for viewing by parents. Thus, various interactive features may be displayed by the kiosk that may improve the user experience for kiosk users of different ages.

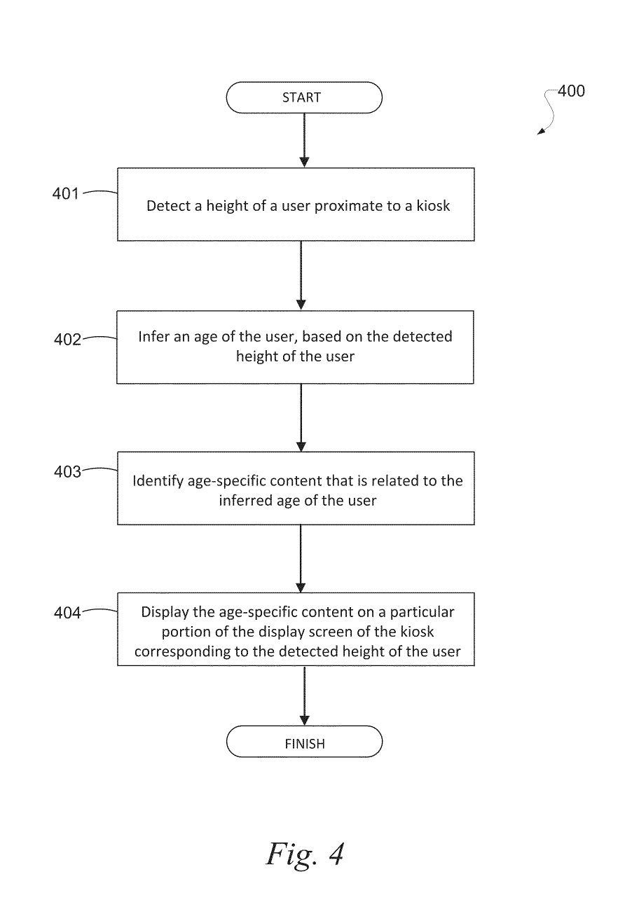

FIG. 4 is a flowchart illustrating an example method 400, consistent with various embodiments described above. The method 400 may be performed at least in part by, for example, the kiosk display system 200 illustrated in FIG. 2 (or an apparatus having similar modules, such as client machines 110 and 112 or application server 118 illustrated in FIG. 1). In operation 401 in FIG. 4, the determination module 202 detects a height of a user proximate to a kiosk. In operation 402 in FIG. 4, the determination module 202 infers an age of the user, based on the detected height of the user that was detected in operation 401. In operation 403 in FIG. 4, the determination module 202 identifies age-specific content that is related to the inferred age of the user that was inferred in operation 402. In operation 404 in FIG. 4, the determination module 202 displays the age-specific content that was identified in operation 403 on a particular portion of the display screen of the kiosk corresponding to the detected height of the user. Various operations in the method 400 may be omitted or rearranged, as necessary.

According to various exemplary embodiments, a mobile application for store assistants is provided, which may be implemented on or executed by the store assistant module 210 in the display system 200. Store assistants may include any staff or employees of a retail store that may assist customers, consumers, and shoppers of the retail store with their shopping needs. For example, store assistants often have various duties that include helping shoppers find product items, providing shoppers with advice about product items, explaining to shoppers the difference between product items, and so on. In some embodiments, the store assistant mobile application enables a store assistant to scan and collect information about a product item of interest to a customer. For example, when a customer indicates to a store assistant that they're interested in a product item (e.g., when the customer asks questions about the product item), the store assistant can take a photograph of the product item or scan a barcode attached to the product item using their smartphone. This scanned information may be passed to the store assistant's mobile application. The store assistant's application can then identify the product item (e.g., based on decoding information in the scanned barcode, or by performing an image recognition process on the photograph of the product item), and the resulting product identification information may be stored in association with the user profile of the customer.

In some embodiments, the product identification information may be used to select online content to be displayed to a user at a later time, and/or to augment the user preference profile or a user taste profile or user interest profile associated with the customer. For example, frequent customers to a particular retail store (which may include customers that have store credit cards, rewards cards, or preferred customer cards associated with the retail store) often have an account with the store that includes an associated user profile including various information about the user (such as purchase history information, financial account information, and so on). Accordingly, the aforementioned product identification information describing the product items of interest to the user may be uploaded into the user profile. Thereafter, when the user visits a home webpage of the retail store, information regarding the scanned product items (e.g., products for sale online, recommendations, advertisements, coupons, reviews, etc.) may be displayed on the webpage. Information regarding similar items (e.g., similar brands, similar sizes, similar styles, etc.) may also be displayed on the homepage. In some embodiments, the aforementioned types of information may also be displayed on other webpages associated with the retail store, including reviews pages, help pages, discussion forums, user profile pages, and so on.

In some embodiments, a store assistant may take a photograph of a customer, and the store assistant mobile application is configured to analyze the photograph to approximate measurements and sizes of clothing that may fit the customer, and display this information on the smartphone of the store assistant. The store assistant mobile application may also superimpose images of various product items (e.g., clothing) over the photograph of the customer.

In some embodiments, the store assistant mobile application includes maps of the retail store and information regarding various product items stored in different parts of the retail store. Accordingly, when the store assistant specifies a particular product item (e.g., entering the product item into a search query bar, or by selecting the product item from a number of product items included in a menu), the store assistant mobile application displays a map of the retail store and directions for traveling from the current location of the mobile device to the section of the retail store where the desired items are located. For example, the store assistant mobile application may superimpose a proposed path or trail onto a map of the retail store. Thus, whenever a customer asks a retail store assistant for directions, the retail store assistant can easily find where the desired item is, and provide the customer with directions to the item. The aspects of the store assistant mobile application described above can also be included in a mobile application for customers.

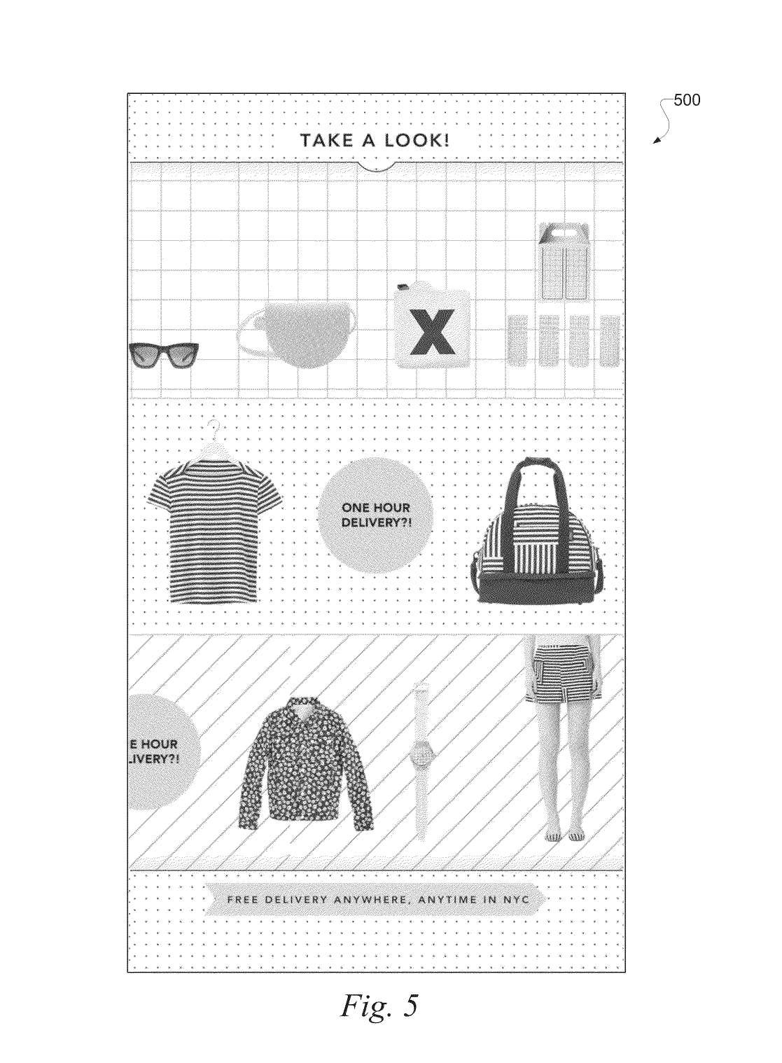

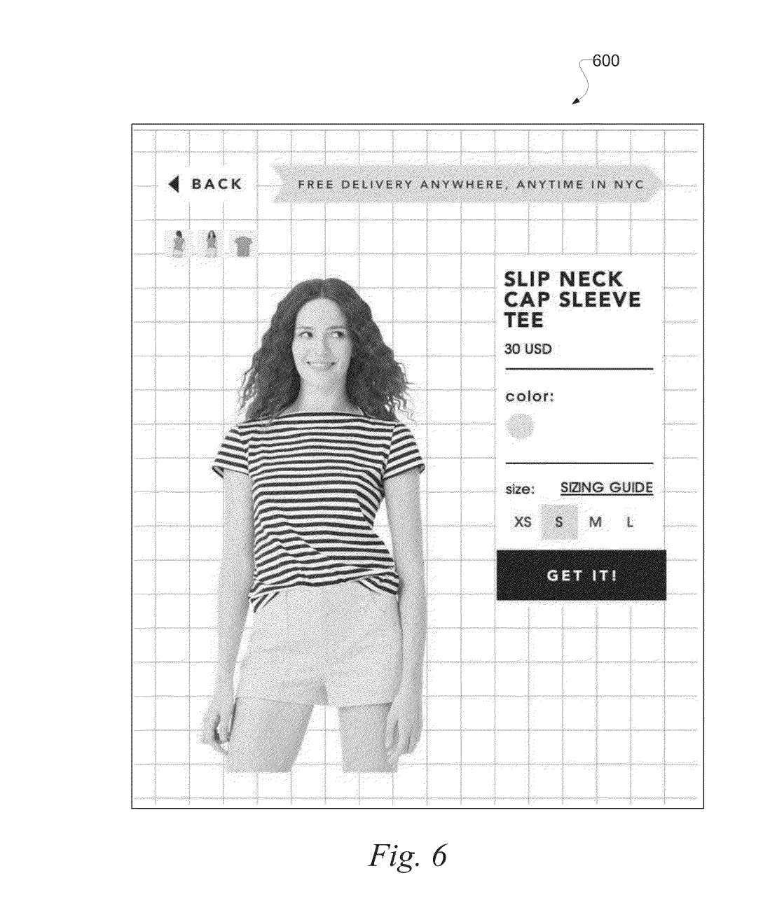

In some embodiments, a shoppable window or a shoppable window user interface thereof may display various content associated with a retail store, online store, or marketplace. For example, the shoppable window may display content related to various product items for sale by the retail store, including item descriptions, pictures, videos, catalogs, product comparison information/tables, advertisements, coupons, promotions, offers, deals, menus, and so on (e.g., see shoppable window user interface 500 in FIG. 5). For example, in some embodiments, the shoppable window may display a menu of various product items for sale in the store. In some embodiments, the shoppable window may display a menu of different categories of items, and when the user selects on one of the categories, the user is displayed with various product items in this category. The shoppable windows allow shoppers to order products on the screen. For example, when a user selects on one of the product items, the shoppable window may display an icon entitled “purchase” or “get it” (e.g., see shoppable window user interface 600 in FIG. 6). When the user selects this icon, the user may enter information to order the item (e.g., financial information such as credit card number, a delivery address, or simply an e-mail address associated with a PayPal account). Accordingly, shoppers may be able to touch the screens to order and have products delivered to them (e.g., within an hour via courier). Payment may accepted by the couriers through online financial accounts (e.g., PayPal, or PayPal Here, a mobile payment service developed by eBay).

It is possible that users may not wish to complete the checkout process on the public kiosk or shoppable window, since they will have to enter personalized information into the public kiosk or shoppable window. Accordingly, in some embodiments, users are able to shop on a display surface (e.g., one of the aforementioned shoppable windows) or a public kiosk, build up their shopping cart, and then transfer very smoothly to a mobile phone to complete the checkout. In other words, a public screen may be utilized for the front end of the purchase process, whereas a private screen (e.g., a screen of the user's smartphone) may be utilized for the backend of the purchase process (e.g., checkout).

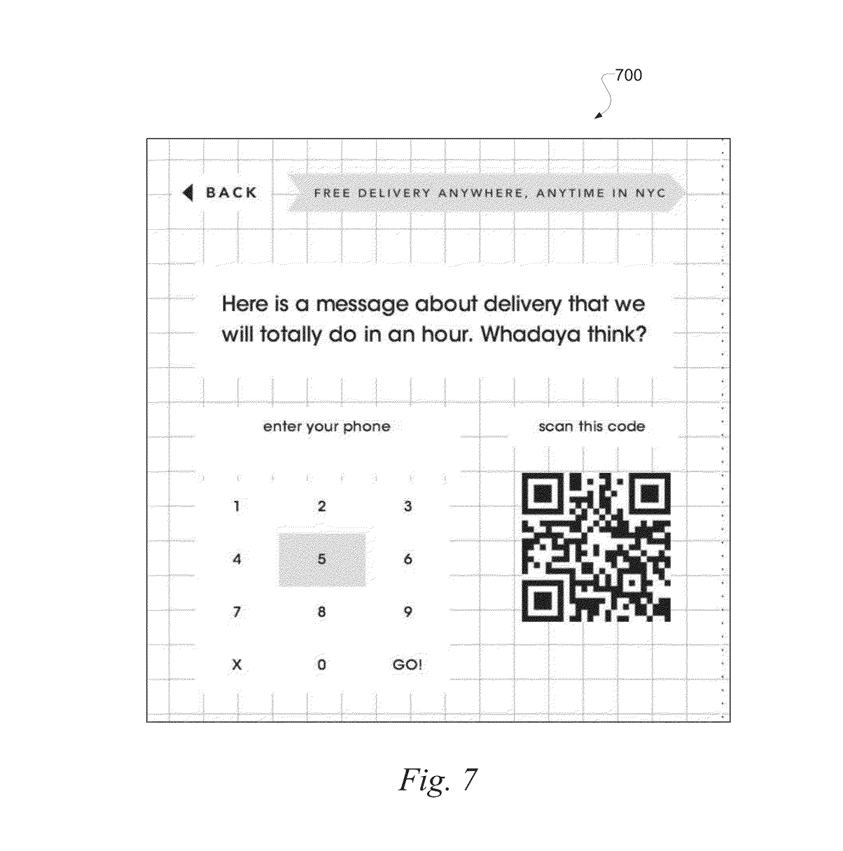

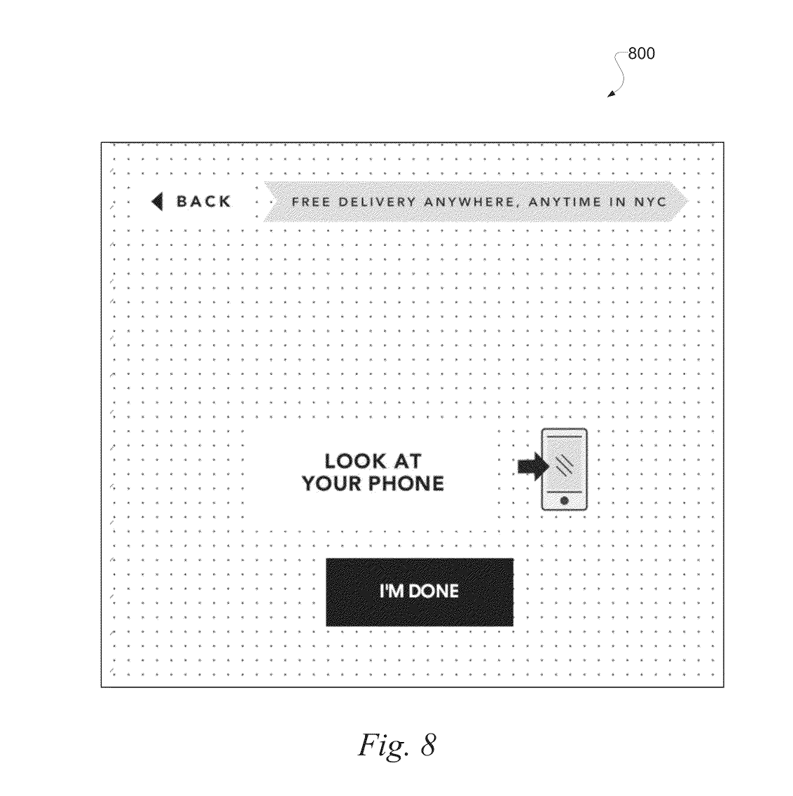

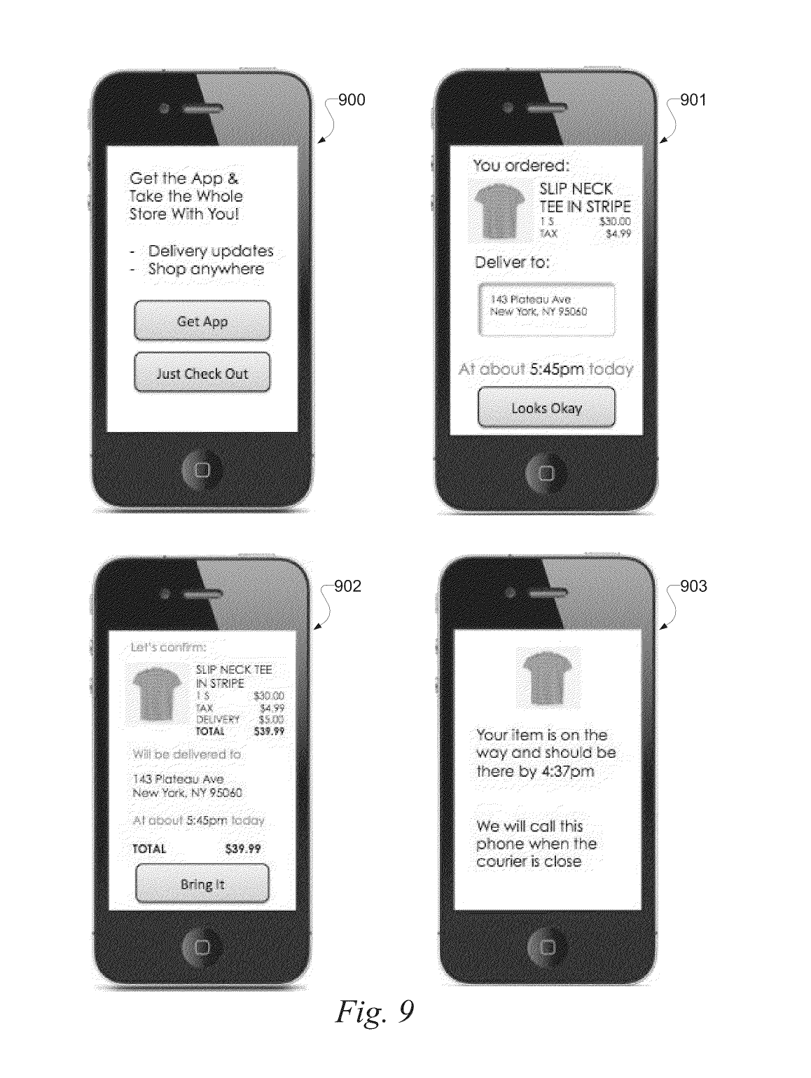

For example, in some embodiments, after the user adds various items to their shopping cart or bag on the shoppable window or kiosk, the user may select a “purchase” button, “get it” button, “check out” button, etc., displayed on the surface of the shoppable window (e.g., see FIG. 6). Thereafter, the shoppable window user interface may display a keypad and prompt the user to enter their telephone number associated with their smartphone (e.g., see shoppable window user interface 700 illustrated in FIG. 7). After the user enters their telephone number, the phone number may be received by the shoppable window display system 200 or an associated server, and the shoppable window display system 200 may transmit a text message (e.g., MMS message or SMS message) to the smartphone of the user with further information for completing the purchase. As illustrated in FIG. 8, the shoppable window display system 200 may display a shoppable window user interface 800 prompting the user to check their phone for the text message. In some embodiments, the aforementioned text message may include a link to a purchase webpage (for rendering by a web browser of the user's smartphone) for the user to enter financial information, delivery address, PayPal account information, etc, and to complete the purchase. For example. FIG. 9 illustrates one or more exemplary purchase webpages 900-903 that may be displayed via a browser on a smartphone allowing the user to complete the checkout process. The webpage 900 provides the user with the opportunity to download a mobile application for the retail store associated with the shoppable window. The webpage 901 then summarizes the order and allows the user to specify/confirm the delivery address, and specifies the estimated delivery time. The webpage 902 then confirms the order of the delivery address, and specifies the estimated charge. The webpage 903 then informs the user that the product is being delivered, and the estimated delivery time. Since the phone number of the user was already supplied, this information may be provided to the delivery person.

In some embodiments, the shoppable window user interface may prompt the user for their e-mail address, screen name, social media handle, etc., instead of (or in addition to) the user's telephone number, and e-mails, social media messages, instant messages, chat messages, etc., may be transmitted to the user, instead of (or in addition to) text messages. In some embodiments, instead of entering a phone number, the shoppable window may display a QR code including a link to a purchase page (e.g., see shoppable window user interface 700 illustrated in FIG. 7), and when the user takes a photograph of the QR code with their smartphone, a browser of the smartphone displays the purchase page for the user to complete the purchase. In other embodiments, the shoppable window user interface may display a passcode and a destination phone number (e.g., a shortcode), and the user may text the passcode to the destination phone number. Thereafter, the shoppable window display system 200 may transmit a text message (e.g., MMS message or SMS message) to the smartphone of the user with information for completing the purchase. For example, the text message may include a link to a purchase webpage (for rendering by a web browser of the user's smartphone) for the user to enter financial information, delivery address, PayPal account information, etc., and complete the purchase.

Accordingly, a traditional physical store may be extended to include various spaces and surfaces that are interesting for consumers to use. The shoppable windows may be utilized to launch new brands or products without opening new physical stores. The shoppable windows may also be used by small retail outlets to let customers buy products that they can't stock on the premises. For instance, shoppable windows may be placed on existing stores to sell things like linens and home furnishings that consume a great deal of space and might not fit in the physical store. Accordingly, shoppable windows may extend the boundaries of traditional physical stores.

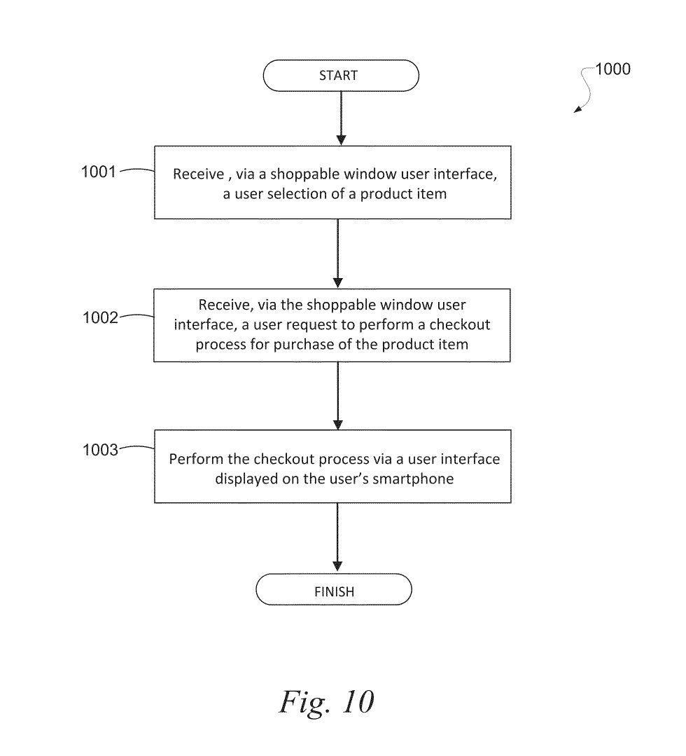

FIG. 10 is a flowchart illustrating an example method 1000, consistent with various embodiments described above. The method 1000 may be performed at least in part by, for example, the shoppable window display system 200 illustrated in FIG. 2 (or an apparatus having similar modules, such as client machines 110 and 112 or application server 118 illustrated in FIG. 1). In operation 1001 in FIG. 10, the content module 204 receives, via a shoppable window user interface associated with a retail store, a user selection of a product item offered for sale by the retail store. In operation 1002 in FIG. 10, the content module 204 receives, via the shoppable window user interface, a user request to perform a checkout process for purchase of the product item. In operation 1003 in FIG. 10, the mobile checkout module 206 performs the checkout process for the purchase of the product item via a user interface displayed on a smartphone associated with the user.

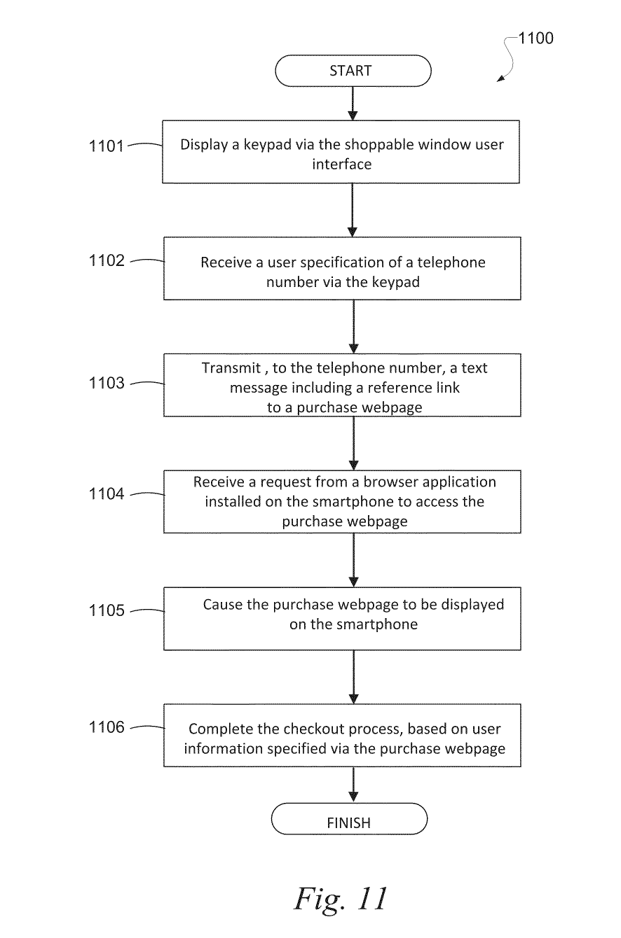

FIG. 11 is a flowchart illustrating an example method 1100 for performing a checkout process (which may correspond to the operation 1003 in FIG. 10), consistent with various embodiments described above. The method 1100 may be performed at least in part by, for example, the shoppable window display system 200 illustrated in FIG. 2 (or an apparatus having similar modules, such as client machines 110 and 112 or application server 118 illustrated in FIG. 1). In operation 1101 in FIG. 11, the mobile checkout module 206 displays a keypad via the shoppable window user interface (e.g., see FIG. 7). In operation 1102 in FIG. 11, the mobile checkout module 206 receives a user specification of a telephone number (e.g., associated with the user's smartphone) via the keypad. In operation 1103 in FIG. 11, the mobile checkout module 206 transmits, to the specified telephone number, a text message including a reference link to a purchase webpage. Thereafter, a browser on the smartphone may attempt to open the purchase webpage (e.g., transmit a request to access the corresponding URL). In operation 1104 in FIG. 11, the mobile checkout module 206 receives a request from a browser application installed on the smartphone to access the purchase webpage. In operation 1105 in FIG. 11, the mobile checkout module 206 causes the purchase webpage to be displayed via the browser application installed on the smartphone. In operation 1106 in FIG. 11, the mobile checkout module 206 completes the checkout process, based on user information specified via the purchase webpage (e.g., financial information, credit card information, delivery information, etc.).

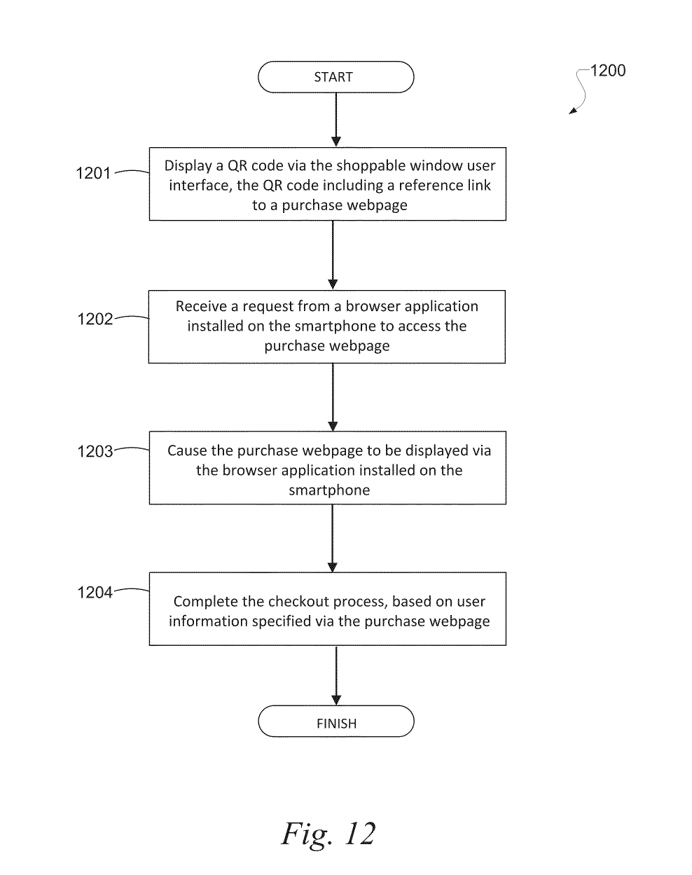

FIG. 12 is a flowchart illustrating an example method 1200 for performing a checkout process (which may correspond to the operation 1003 in FIG. 10), consistent with various embodiments described above. The method 1200 may be performed at least in part by, for example, the shoppable window display system 200 illustrated in FIG. 2 (or an apparatus having similar modules, such as client machines 110 and 112 or application server 118 illustrated in FIG. 1). In operation 1201 in FIG. 12, the mobile checkout module 206 displays a QR code via the shoppable window user interface (e.g., see FIG. 7), the QR code including a reference link (e.g., URL) to a purchase webpage. Thereafter, if the user takes a photo of the QR code with their smartphone, a browser on the smartphone may attempt to open the purchase webpage (e.g., transmit a request to access the corresponding URL). In operation 1202 in FIG. 12, the mobile checkout module 206 receives a request from a browser application installed on the smartphone to access the purchase webpage. In operation 1203 in FIG. 12, the mobile checkout module 206 causes the purchase webpage to be displayed via the browser application installed on the smartphone. In operation 1204 in FIG. 12, the mobile checkout module 206 completes the checkout process, based on user information specified via the purchase webpage (e.g., financial information, credit card information, delivery information, etc.).

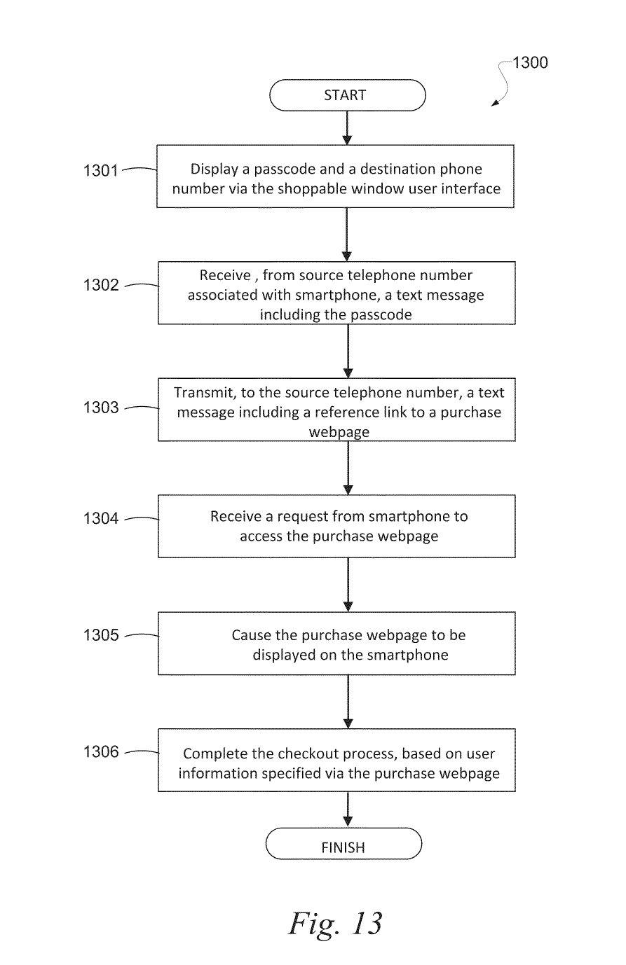

FIG. 13 is a flowchart illustrating an example method 1300 for performing a checkout process (which may correspond to the operation 1003 in FIG. 10), consistent with various embodiments described above. The method 1300 may be performed at least in part by, for example, the shoppable window display system 200 illustrated in FIG. 2 (or an apparatus having similar modules, such as client machines 110 and 112 or application server 118 illustrated in FIG. 1). In operation 1301 in FIG. 13, the mobile checkout module 206 displays a passcode and a destination phone number (e.g., shortcode) via the shoppable window user interface. The passcode may be unique and periodically changing, for security reasons. A user may then text the passcode to the destination phone number. In operation 1302 in FIG. 13, the mobile checkout module 206 receives, from a source telephone number associated with the user's smartphone, a text message directed to the destination phone number, the text message including the passcode. In operation 1303 in FIG. 13, the mobile checkout module 206 transmits, to the source telephone number, a text message including a reference link to a purchase webpage. Thereafter, a browser on the smartphone may attempt to open the purchase webpage (e.g., transmit a request to access the corresponding URL). In operation 1304 in FIG. 13, the mobile checkout module 206 receives a request from a browser application installed on the smartphone to access the purchase webpage. In operation 1305 in FIG. 13, the mobile checkout module 206 causes the purchase webpage to be displayed via the browser application installed on the smartphone. In operation 1306 in FIG. 13, the mobile checkout module 206 completes the checkout process, based on user information specified via the purchase webpage (e.g., financial information, credit card information, delivery information, etc.).

According to various exemplary embodiments, phone-to-digital wall interaction may be initiated by changing phone orientation from portrait to landscape. For example, according to various embodiments, a user may turn or rotate their mobile device in order to initiate or trigger an interactive session between the mobile device and another device. For example, in some embodiments, when a user points a camera of their mobile device at a kiosk, billboard, or shoppable window, and if the user rotates or turns their mobile device (e.g., 90° clockwise), the turning motion may be detected by the mobile device (e.g., using accelerometers or gyroscopes included in the mobile device). The mobile device and/or the shoppable window display system 200 may then initiate or establish a communication session between the mobile device and the shoppable window display system 200 (e.g. by launching a mobile application or a webpage in a web browser of the mobile device, based on information scanned by the camera of the mobile device from the kiosk or shoppable window). Thereafter, content may be pushed from the kiosk or remote server to the mobile device, including content related to a shopping experience. This feature may be referred to as a “turn to play” feature in various embodiments throughout.

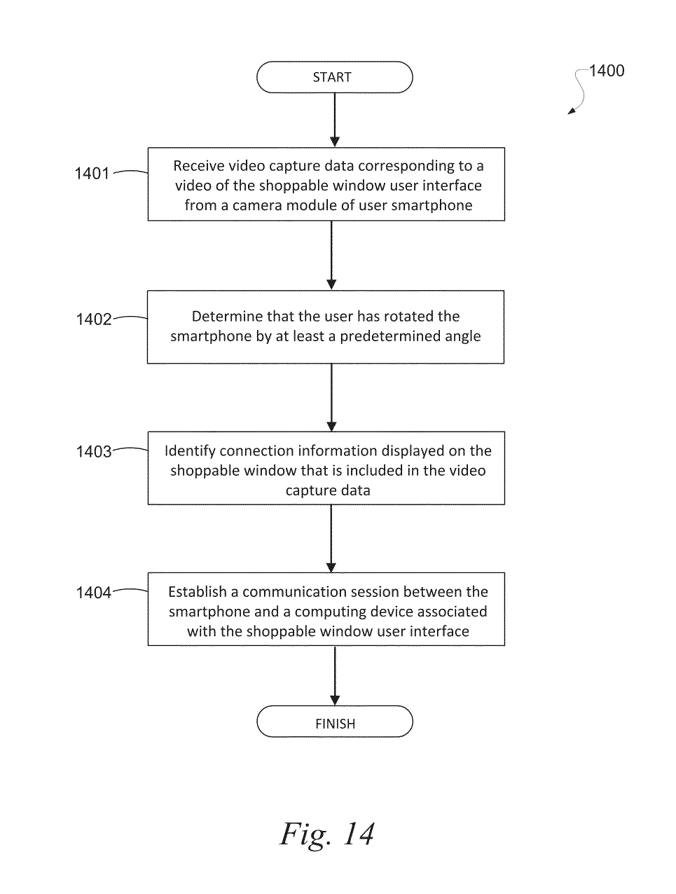

FIG. 14 is a flowchart illustrating an example method 1400, consistent with various embodiments described above. The method 1400 may be performed at least in part by, for example, the shoppable window display system 200 illustrated in FIG. 2 (or an apparatus having similar modules, such as client machines 110 and 112 or application server 118 illustrated in FIG. 1). In operation 1401 in FIG. 14, the connection module 208 receives video capture data corresponding to a video of the shoppable window user interface from a camera module of a smartphone associated with a user. In operation 1402 in FIG. 14, the connection module 208 determines that the user has rotated the smartphone by at least a predetermined angle (e.g., based on sensor data from accelerometers, gyroscopes, or other sensors included in the mobile device). In operation 1403 in FIG. 14, the connection module 208 identifies connection information displayed on the shoppable window that is included in the video capture data (e.g., encoded into a displayed QR code). In operation 1404 in FIG. 14, the connection module 208 establishes a communication session between the smartphone and a computing device associated with the shoppable window user interface, based on the connection information.

According to various exemplary embodiments, a wireless access point may be setup inside the storefront window or shoppable window. The aforementioned wireless access point may be similar to other wireless access points that enable various devices (e.g., mobile devices such as tablets and smartphones) to connect to a network such as the Internet, although in this case the wireless access point is specifically tied to a particular shoppable window. For example, when the user approaches the shoppable window with their smartphone, the smartphone may automatically attempt to connect to the wireless access point associated with the shoppable window. In some embodiments, this may cause an authentication prompt to be displayed in a webpage of a web browser of the smartphone, or via push notification (e.g., text message) displayed on the smartphone, requesting the user to authenticate themselves by clicking on an “agree” button, for example. Accordingly, this authentication method may be utilized to leverage a shopping experience, so that no further interaction between the user and the shoppable window is necessary. In other words, by connecting to the wireless access point and launching the authentication screen, a session may immediately be initiated between the user smartphone and the shoppable window (or remote server associated with the shoppable window). Thereafter, WebSocket technology may be utilized to transfer data back and forth between the kiosk/shoppable window and the smartphone. Accordingly, the user may initiate a communication session between a smartphone and a shoppable window through a relatively frictionless experience.

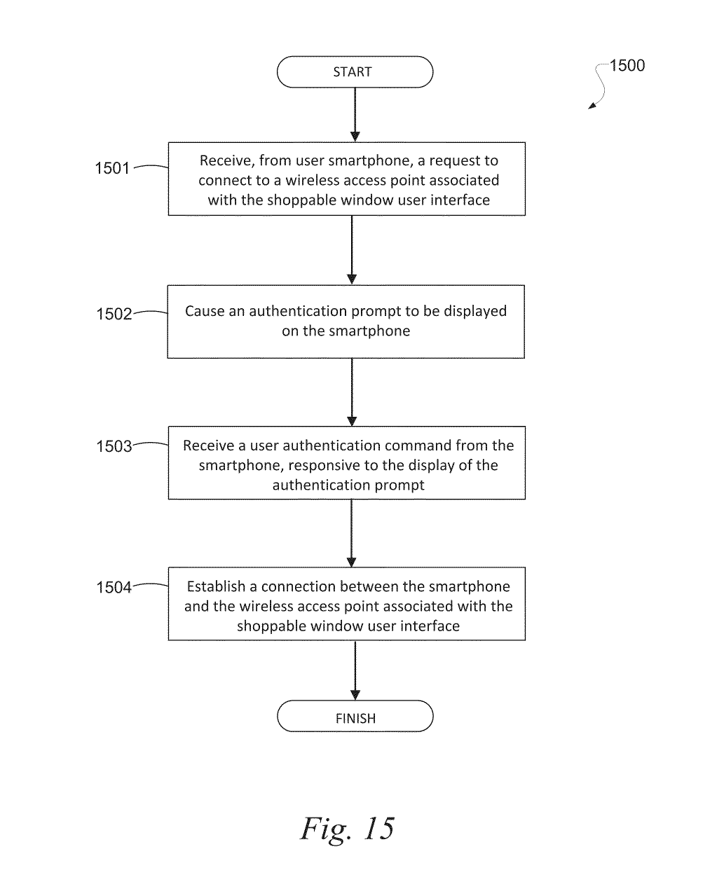

FIG. 15 is a flowchart illustrating an example method 1500, consistent with various embodiments described above. The method 1500 may be performed at least in part by, for example, the shoppable window display system 200 illustrated in FIG. 2 (or an apparatus having similar modules, such as client machines 110 and 112 or application server 118 illustrated in FIG. 1). In operation 1501 in FIG. 15, the connection module 208 receives, from the smartphone associated with the user, a request to connect to a wireless access point associated with the shoppable window user interface. In operation 1502 in FIG. 15, the connection module 208 causes an authentication prompt to be displayed on the smartphone via a push notification message or a webpage in a web browser application installed on the smartphone. In operation 1503 in FIG. 15, the connection module 208 receives a user authentication command from the smartphone, responsive to the display of the authentication prompt on the smartphone. In operation 1504 in FIG. 15, the connection module 208 establishes a connection between the smartphone and the wireless access point associated with the shoppable window user interface, based on the user authentication command.

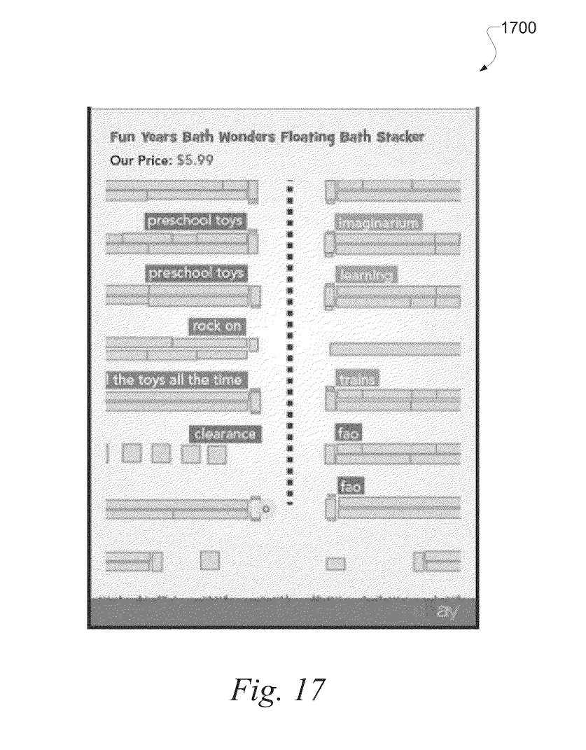

As described herein, a session or connection may be established between a smartphone and a shoppable window or kiosk, using various techniques described above, including the aforementioned “turn to play” feature, or by connecting to a wireless access point associated with a shoppable window, or by entering a phone number via keypad displayed on the shoppable window, or by scanning a QR code displayed on the shoppable window, or by texting a passcode displayed on the shoppable window, and so on. After a session or connection is established between the smartphone and the shoppable window, content may be pushed to the smartphone via text messages, or content may be displayed in webpages on the web browser of the smartphone. Accordingly, the user may be presented with personalized content such as coupons, brochures, catalogs, advertisements, deals, promotions, etc. For example, if the user utilizes the shoppable window or kiosk to browse for select product items, log data describing this browsing activity may be stored (e.g., in the database 212), and then information related to these items may be passed to the mobile device by the display system 200. In another embodiment, a map of a retail store associated with the kiosk or shoppable window with directions from the current location of the kiosk to the location of the product items of interest may be pushed to the smartphone (e.g., see the user interface 1700 in FIG. 17). In other embodiments, a merchant specific balance (e.g., a coupon for credits for only a specific retail store where the kiosk is located) may be pushed to the smartphone.

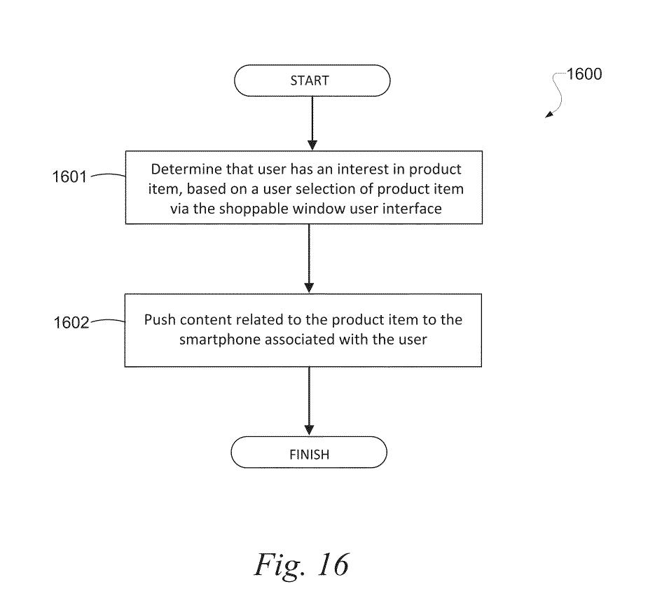

FIG. 16 is a flowchart illustrating an example method 1600, consistent with various embodiments described above. The method 1600 may be performed at least in part by, for example, the shoppable window display system 200 illustrated in FIG. 2 (or an apparatus having similar modules, such as client machines 110 and 112 or application server 118 illustrated in FIG. 1). In operation 1601 in FIG. 16, the determination module 202 determines that that the user has an interest in a product item, based on a user selection of the product item via the shoppable window user interface. In operation 1602 in FIG. 16, the content module 204 pushes content related to the product item to the smartphone associated with the user. In some embodiments, the pushed content comprises product information, coupons, or advertisements related to the product item. In some embodiments, the pushed content comprises a map of the retail store with directions from the current location of the shoppable window user interface to the product item (e.g., see FIG. 17). In some embodiments, the pushed content comprises information describing a merchant specific balance associated with the retail store. In some embodiments, the pushing in operation 1603 may comprise displaying the content on a web browser application installed on the smartphone. In other embodiments, the pushing in operation 1603 may comprise transmitting a push notification or text message to the smartphone, the push notification or text message including a reference link for accessing the content.

In some embodiments, when a user identifies or demonstrates an interest in particular items, these items may be preloaded for a fitting room. The user may indicate an interest in an item by selecting the item on the webpage or retail store, or selecting/touching the item on one of the aforementioned shoppable windows or a kiosk, or by scanning or taking a photograph of an item displayed on a shoppable window or a kiosk, and so on. In some embodiments, RFID tags or similar devices may be included in the product items (e.g., clothes) or attached equipment (e.g., coat hangers), and when movement is detected in the RFID tag by an RFID scanner (e.g., in the mobile device of a user or store assistant), this may be registered as interest by the nearby user. After the display system 200 determines that the user has expressed an interest in product items associated with a retail store, the application may transmit information to store assistant at the retail store, so that store assistants may collect the appropriate product items and place them in a fitting room. Thus, when the user enters the store and/or approaches the fitting room, the items they are interested are already present in the fitting room.

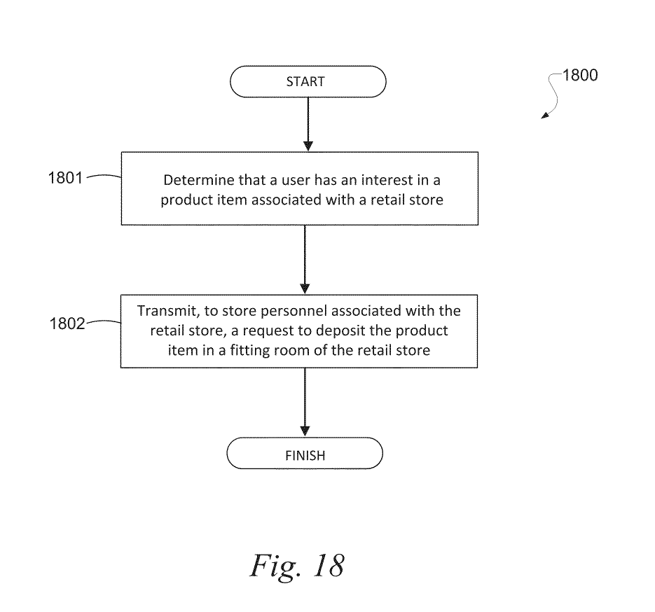

FIG. 18 is a flowchart illustrating an example method 1800, consistent with various embodiments described above. The method 1800 may be performed at least in part by, for example, the display system 200 illustrated in FIG. 2 (or an apparatus having similar modules, such as client machines 110 and 112 or application server 118 illustrated in FIG. 1). In operation 1801 in FIG. 18, the determination module 202 determines that a user has an interest in a product item associated with a retail store. For example, the determination module 202 may receive a user specification of the product item via a user interface displayed on a kiosk or shoppable window. As another example, the determination module 202 may receive image capture data corresponding to a photograph of the product item from a camera module of the smartphone associated with the user. In operation 1802 in FIG. 18, the content module 204 transmits, to store personnel associated with the retail store, a request to deposit the product item in a fitting room of the retail store.

According to various exemplary embodiments, other devices such as lights, speakers, robotics, mechanize clothes racks, etc. may be connected to a kiosk or shoppable window, and as the user interacts with the kiosk (or smartphone engaged in a communication session with the kiosk), the user may control the attached devices. For example, the kiosk (or smartphone) may display menus and controls for controlling the aforementioned devices.

### Example Mobile Device

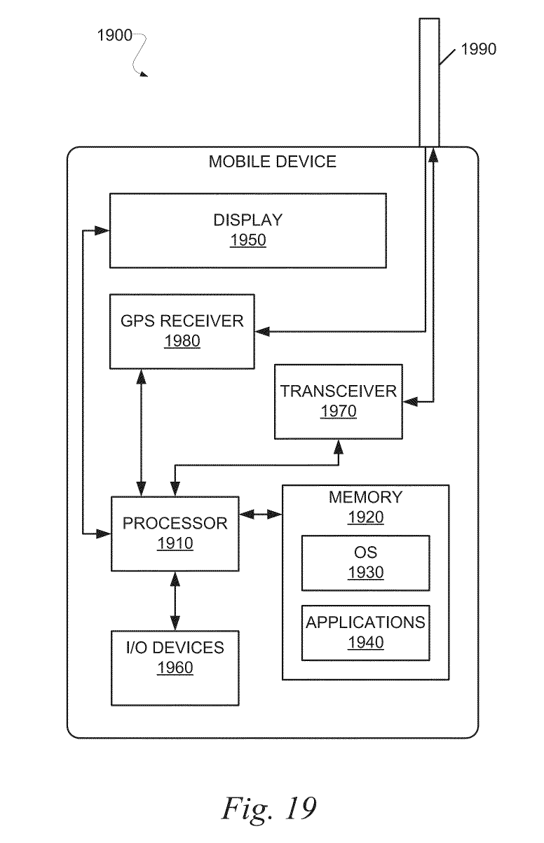

FIG. 19 is a block diagram illustrating the mobile device 1900, according to an example embodiment. The mobile device may correspond to, for example, client machines 110 and 112 or application server 118 illustrated in FIG. 1. One or more of the modules of the system 200 illustrated in FIG. 2 may be implemented on or executed by the mobile device 1900. The mobile device 1900 may include a processor 1910. The processor 1910 may be any of a variety of different types of commercially available processors suitable for mobile devices (for example, an XScale architecture microprocessor, a Microprocessor without Interlocked Pipeline Stages (MIPS) architecture processor, or another type of processor). A memory 1920, such as a Random Access Memory (RAM), a Flash memory, or other type of memory, is typically accessible to the processor 1910. The memory 1920 may be adapted to store an operating system (OS) 1930, as well as application programs 1940, such as a mobile location enabled application that may provide location based services to a user. The processor 1910 may be coupled, either directly or via appropriate intermediary hardware, to a display 1950 and to one or more input/output (I/O) devices 1960, such as a keypad, a touch panel sensor, a microphone, and the like. Similarly, in some embodiments, the processor 1910 may be coupled to a transceiver 1970 that interfaces with an antenna 1990. The transceiver 1970 may be configured to both transmit and receive cellular network signals, wireless data signals, or other types of signals via the antenna 1990, depending on the nature of the mobile device 1900. Further, in some configurations, a GPS receiver 1980 may also make use of the antenna 1990 to receive GPS signals.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is a tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (S10S). For example, at least some of the operations may be performed by a group of computers (as examples of machines including processors), these operations being accessible via a network (e.g., the Internet) and via one or more appropriate interfaces (e.g., Application Program Interfaces (APIs).)

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium

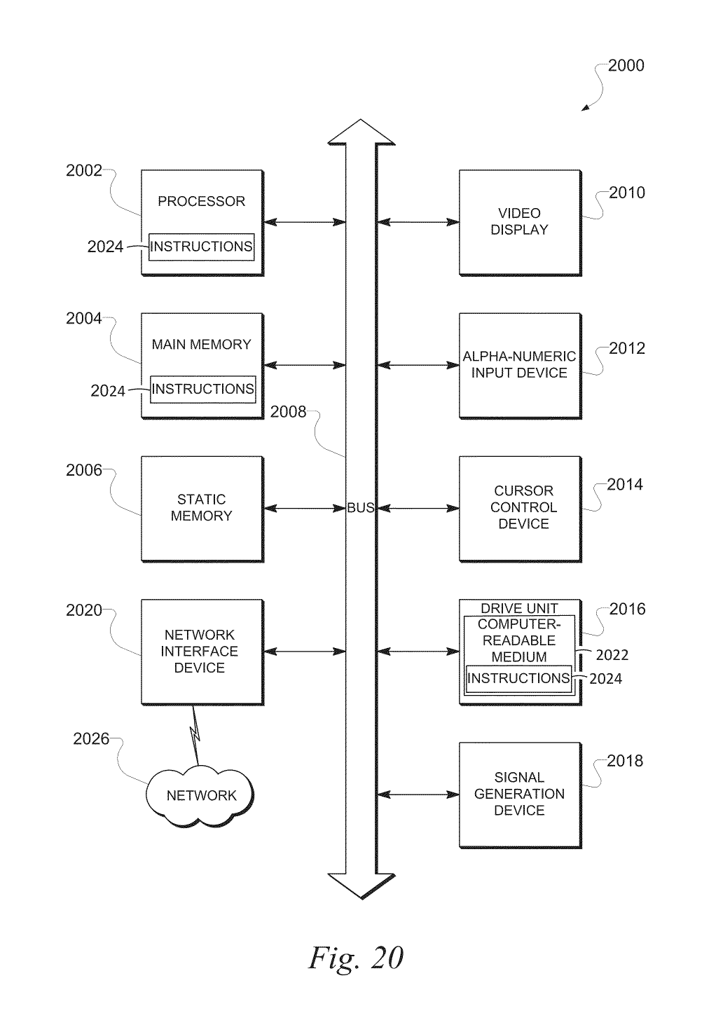

FIG. 20 is a block diagram of machine in the example form of a computer system 2000 within which instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 2000 includes a processor 2002 (e.g., a central processing unit (CPU), a graphics processing unit (GPU) or both), a main memory 2004 and a static memory 2006, which communicate with each other via a bus 2008. The computer system 2000 may further include a video display unit 2010 (e.g., a liquid crystal display (LCD) or a cathode ray tube (CRT)). The computer system 2000 also includes an alphanumeric input device 2012 (e.g., a keyboard or a touch-sensitive display screen), a user interface (UI) navigation device 2014 (e.g., a mouse), a disk drive unit 2016, a signal generation device 2018 (e.g., a speaker) and a network interface device 2020.

### Machine-Readable Medium

The disk drive unit 2016 includes a machine-readable medium 2022 on which is stored one or more sets of instructions and data structures (e.g., software) 2024 embodying or utilized by any one or more of the methodologies or functions described herein. The instructions 2024 may also reside, completely or at least partially, within the main memory 2004 and/or within the processor 2002 during execution thereof by the computer system 2000, the main memory 2004 and the processor 2002 also constituting machine-readable media.

While the machine-readable medium 2022 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding or carrying instructions for execution by the machine and that cause the machine to perform any one or more of the methodologies of the present invention, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (16PROM), and flash memory devices; magnetic disks such as internal hard disks and removable disks; magneto-optical disks; and CD-ROM and DVD-ROM disks.

### Transmission Medium

The instructions 2024 may further be transmitted or received over a communications network 2026 using a transmission medium. The instructions 2024 may be transmitted using the network interface device 2020 and any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., WiFi, LTE, and WiMAX networks). The term “transmission medium” shall be taken to include any intangible medium that is capable of storing, encoding or carrying instructions for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A computer-implemented method comprising:
receiving, via a shoppable window user interface associated with a retail store, a user selection of a product item offered for sale by the retail store;
receiving, via the shoppable window user interface, a user request to perform a checkout process for purchase of the product item; and
performing the checkout process for the purchase of the product item via a user interface displayed on a mobile device associated with the user.

2. The method of claim 1, wherein the performing further comprises:
displaying a keypad via the shoppable window user interface;
receiving a user specification of a telephone number via the keypad;
transmitting, to the telephone number, a text message including a reference link to a purchase webpage;
receiving a request from a browser application installed on the mobile device to access the purchase webpage;
causing the purchase webpage to be displayed via the browser application installed on the mobile device; and
completing the checkout process, based on user information specified via the purchase webpage.

3. The method of claim 1, wherein the performing further comprises:
displaying a QR code via the shoppable window user interface, the QR code including a reference link to a purchase webpage;
receiving a request from a browser application installed on the mobile device to access the purchase webpage;
causing the purchase webpage to be displayed via the browser application installed on the mobile device; and
completing the checkout process, based on user information specified via the purchase webpage.

4. The method of claim 1, wherein the performing further comprises:
displaying a passcode and a destination phone number via the shoppable window user interface;
receiving, from a source telephone number associated with the mobile device, a text message directed to the destination phone number, the text message including the passcode;
transmitting, to the source telephone number, a text message including a reference link to a purchase webpage;
receiving a request from a browser application installed on the mobile device to access the purchase webpage;
causing the purchase webpage to be displayed via the browser application installed on the mobile device; and
completing the checkout process, based on user information specified via the purchase webpage.

5. The method of claim 1, further comprising:
determining that the user has an interest in a product item, based on a user selection of the product item via the shoppable window user interface; and
pushing content related to the product item to the mobile device associated with the user.

6. The method of claim 5, wherein the pushed content comprises product information, coupons, or advertisements related to the product item.

7. The method of claim 5, wherein the pushed content comprises a map of the retail store with directions from the current location of the shoppable window user interface to the product item.

8. The method of claim 5, wherein the pushed content comprises information describing a merchant specific balance associated with the retail store.

9. The method of claim 5, wherein the pushing further comprises at least one of:
displaying the content on a web browser application installed on the mobile device; and
transmitting a push notification or text message to the mobile device, the push notification or text message including a reference link for accessing the content.

10. The method of claim 1, further comprising:
receiving video capture data corresponding to a video of the shoppable window user interface from a camera module of the mobile device associated with the user;
determining that the user has rotated the mobile device by at least a predetermined angle;
identifying connection information displayed on the shoppable window that is included in the video capture data; and
establishing a communication session between the mobile device and a computing device associated with the shoppable window user interface, based on the connection information.

11. The method of claim 1, further comprising:
receiving, from the mobile device associated with the user, a request to connect to a wireless access point associated with the shoppable window user interface;
causing an authentication prompt to be displayed on the mobile device via a push notification message or a webpage in a web browser application installed on the mobile device;
responsive to the display of the authentication prompt, receiving a user authentication command from the mobile device; and
establishing a connection between the mobile device and the wireless access point associated with the shoppable window user interface, based on the user authentication command.

12. A system comprising:
a machine including a memory and at least one processor; and
a shoppable window checkout module, executable by the machine, configured to:
receive, via a shoppable window user interface associated with a retail store, a user selection of a product item offered for sale by the retail store;
receive, via the shoppable window user interface, a user request to perform a checkout process for purchase of the product item; and
perform the checkout process for the purchase of the product item via a user interface displayed on a mobile device associated with the user.

13. The system of claim 12, wherein the performing further comprises:
displaying a keypad via the shoppable window user interface;
receiving a user specification of a telephone number via the keypad;
transmitting, to the telephone number, a text message including a reference link to a purchase webpage;
receiving a request from a browser application installed on the mobile device to access the purchase webpage;
causing the purchase webpage to be displayed via the browser application installed on the mobile device; and
completing the checkout process, based on user information specified via the purchase webpage.

14. The system of claim 12, wherein the performing further comprises:
displaying a QR code via the shoppable window user interface, the QR code including a reference link to a purchase webpage;
receiving a request from a browser application installed on the mobile device to access the purchase webpage;
causing the purchase webpage to be displayed via the browser application installed on the mobile device; and
completing the checkout process, based on user information specified via the purchase webpage.

15. The system of claim 12, wherein the performing further comprises:
displaying a passcode and a destination phone number via the shoppable window user interface;
receiving, from a source telephone number associated with the mobile device, a text message directed to the destination phone number, the text message including the passcode;
transmitting, to the source telephone number, a text message including a reference link to a purchase webpage;
receiving a request from a browser application installed on the mobile device to access the purchase webpage;
causing the purchase webpage to be displayed via the browser application installed on the mobile device; and
completing the checkout process, based on user information specified via the purchase webpage.

16. A non-transitory machine-readable storage medium comprising instructions that, when executed by one or more processors of a machine, cause the machine to perform operations comprising:
receiving, via a shoppable window user interface associated with a retail store, a user selection of a product item offered for sale by the retail store;
receiving, via the shoppable window user interface, a user request to perform a checkout process for purchase of the product item; and
performing the checkout process for the purchase of the product item via a user interface displayed on a mobile device associated with the user.

17. The storage medium of claim 16, wherein the performing further comprises:
displaying a keypad via the shoppable window user interface;
receiving a user specification of a telephone number via the keypad;
transmitting, to the telephone number, a text message including a reference link to a purchase webpage;
receiving a request from a browser application installed on the mobile device to access the purchase webpage;
causing the purchase webpage to be displayed via the browser application installed on the mobile device; and
completing the checkout process, based on user information specified via the purchase webpage.

18. The storage medium of claim 16, wherein the performing further comprises:
displaying a QR code via the shoppable window user interface, the QR code including a reference link to a purchase webpage;
receiving a request from a browser application installed on the mobile device to access the purchase webpage;
causing the purchase webpage to be displayed via the browser application installed on the mobile device; and
completing the checkout process, based on user information specified via the purchase webpage.

19. The storage medium of claim 16, wherein the performing further comprises:
displaying a passcode and a destination phone number via the shoppable window user interface;
receiving, from a source telephone number associated with the mobile device, a text message directed to the destination phone number, the text message including the passcode;
transmitting, to the source telephone number, a text message including a reference link to a purchase webpage;
receiving a request from a browser application installed on the mobile device to access the purchase webpage;
causing the purchase webpage to be displayed via the browser application installed on the mobile device; and
completing the checkout process, based on user information specified via the purchase webpage.
